(19) United States
(12) Patent Application Publication
(10) Pub. No.: US 2020/0278130 A1
(43) Pub. Date: Sep. 3, 2020

(54) OPERATION CONTROL METHOD, STORAGE MEDIUM, AND OPERATION CONTROL DEVICE

(71) Applicant: FUJITSU LIMITED, Kawasaki-shi (JP)

(72) Inventor: TAKESHI KONNO, Kawasaki (JP)

(73) Assignee: FUJITSU LIMITED, Kawasaki-shi (JP)

(21) Appl. No.: 16/800,673

(22) Filed: Feb. 25, 2020

(30) Foreign Application Priority Data
Feb. 28, 2019 (JP) 2019-036728

(51) Int. Cl. F24F 11/64; F24F 11/58

(52) U.S. Cl. CPC F24F 11/64; G06N 20/00; F24F 11/58

(57) ABSTRACT

An operation control method executed by a computer, the operation control method includes extracting, based on statistical information that is associated with a heat storage factor of a target space and is generated from an operation result of a first air conditioner, information related to plurality of other air conditioners similar to the first air conditioner; and executing an operation of the first air conditioner based on the extracted information.

### CROSS-REFERENCE TO RELATED APPLICATION

This application is based upon and claims the benefit of priority of the prior Japanese Patent Application No. 2019-36728, filed on Feb. 28, 2019, the entire contents of which are incorporated herein by reference.

### FIELD

The embodiments discussed herein are related to an operation control method, a storage medium, and an operation control device.

### BACKGROUND

Air-conditioning control is performed to control an air conditioner and the like such that the room temperature becomes comfortable for the user. For example, there is a technology that predicts the room temperature in several minutes using observation values of a sensor and weather information and generates an operation plan for realizing a target room temperature change based on the predicted value. Examples of the related art are International Publication Pamphlet No. WO 2014/112320 and Japanese Laid-open Patent Publication No. 2015-148417.

### SUMMARY

According to an aspect of the embodiments, an operation control method executed by a computer, the operation control method includes extracting, based on statistical information that is associated with a heat storage factor of a target space and is generated from an operation result of a first air conditioner, information related to a plurality of other air conditioners similar to the first air conditioner; and executing an operation of the first air conditioner based on the extracted information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an entire configuration of a system according to a first embodiment;

FIG. 2 is a diagram for describing a room;

FIGS. 3A and 3B are diagrams for describing an influence of a heat storage capacity;

FIG. 4 is a functional block diagram illustrating a functional configuration of an air-conditioning control server according to the first embodiment;

FIG. 5 is a diagram illustrating an example of information stored in a sensor value database (DB);

FIG. 6 is a diagram illustrating an example of information stored in an operation log DB;

FIG. 7 is a diagram illustrating results of calculation of a similarity between outside temperatures;

FIG. 8 is a diagram illustrating results of calculation of a similarity between room temperatures;

FIG. 9 is a diagram for describing a heat storage factor;

FIG. 10 is a diagram for describing a method for calculating a heat storage factor;

FIG. 11 is a diagram for describing calculation of a heat storage factor;

FIG. 12 is diagram for describing selection of a heat storage factor;

FIG. 13 is a flowchart illustrating a flow of processing;

FIG. 14 is a diagram for describing an effect; and

FIG. 15 is a diagram illustrating an example of a hardware configuration.

### DESCRIPTION OF EMBODIMENTS

With the operation control method that is performed based on the room temperature sensed by the air conditioner and the set temperature, however, it may not be possible to appropriately control the room temperature to the set temperature depending on the environment in which the air conditioner is installed. Therefore, there is a technology under consideration that performs appropriate operation control by estimating a heat storage factor. The heat storage factor indicates the heat insulation condition or the heat storage condition of a target space for which air-conditioning control is performed.

For example, since the heat storage factor is appropriately estimated with actual operation results for a certain period of time such as three weeks, the operation may not be performed appropriately before the certain period of time elapses. Even when it is possible to refer to data regarding the operation control of other air conditioners through the network, it is not possible to refer to appropriate data unless control parameters regarding the target air conditioner are appropriate. In many cases, moreover, detailed information regarding the installation environments and the users of other air conditioners is not included in the data that may be referred to through the network due to privacy issues. In view of the foregoing, it is desirable that air-conditioning control using appropriate control parameters be performed.

Embodiments of an operation control method, an operation control program, and an operation control device disclosed in the present application will be described in detail with reference to the drawings. The present invention is not limited to the embodiments. The embodiments may be appropriately combined as long as no contradiction occurs.

### First Embodiment

### Entire Configuration

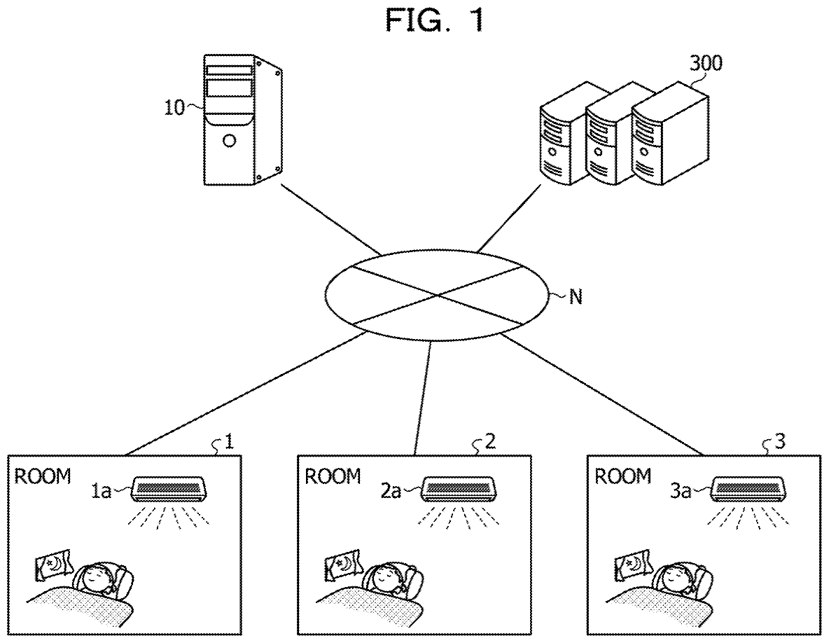

FIG. 1 is a diagram illustrating an example of an entire configuration of a system according to a first embodiment. In this system, as illustrated in FIG. 1, an air-conditioning control server 10, air conditioners 1a to 3a, and an external server group 300 are coupled to each other via a network N so as to be communicable with each other. The air-conditioning control server 10 is an example of an operation control device. The air conditioners 1a to 3a (hereinafter, occasionally referred to as “air conditioners”) are respectively installed in rooms 1 to 3, which are examples of spaces for which air-conditioning control is performed. The air-conditioning control server 10 may be a server device that uses a cloud service as illustrated in FIG. 1 or may be installed in each room. The network N may employ various wired and wireless communication networks such as the Internet.

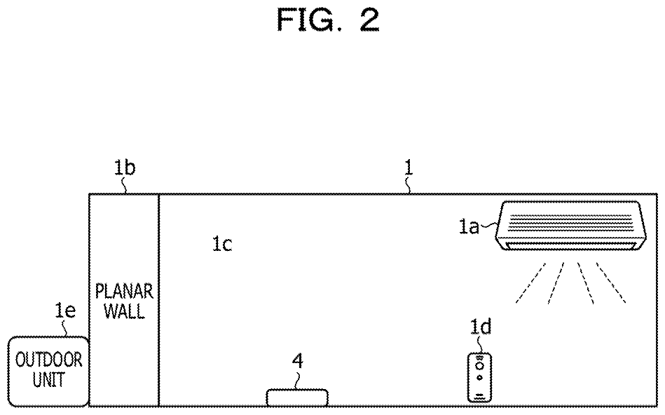

Since each room includes a similar configuration, the room 1 will be described. FIG. 2 is a diagram for describing the room 1. As illustrated in FIG. 2, a room includes an outer wall 1b, an air conditioner 1a, an outdoor unit 3, and a sensor 4. The outer wall 1b shields an interior 1c from the outside. The air conditioner 1a is installed in the interior 1c. The outdoor unit 3 is installed outside the room 1. The sensor 4 is installed in the interior 1c. The outer wall 1b is influenced by the outside temperature and stores heat. The air conditioner 1a is an air conditioner or the like that cools or heats the room 1 and performs air-conditioning control in response to an instruction from a remote controller 1d or the like or the air-conditioning control server 10. The air conditioner 1a collects an operation log in which ON/OFF of the air-conditioning control is associated with the time, and transmits the operation log to the air-conditioning control server 10.

The outdoor unit 3 is an outdoor unit of the air conditioner 1a and includes a sensor (not illustrated) for measuring the outside temperature and a compressor (not illustrated). The sensor 4 collects the temperature in the room (room temperature) and the outdoor temperature (outside temperature) acquired from the sensor of the outdoor unit 3 and transmits these temperatures to the air-conditioning control server 10. The compressor compresses refrigerants into high-temperature and high-pressure refrigerants. The compressor is driven by an inverter and the operation capacity of the compressor is controlled according to the air conditioning condition.

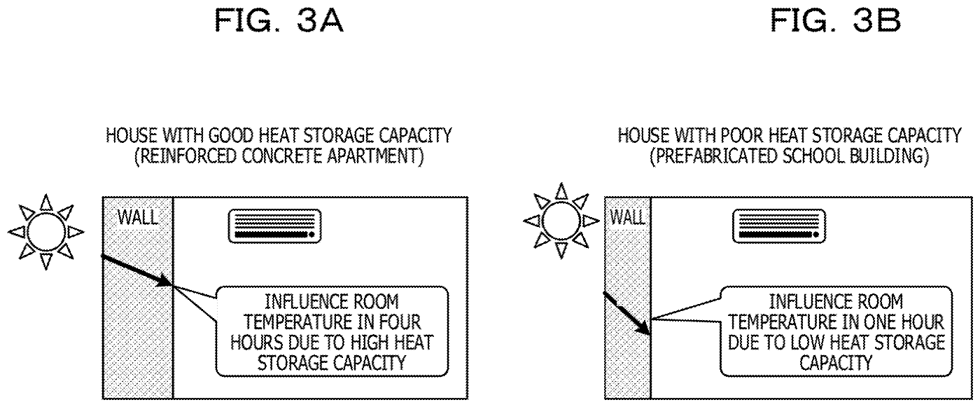

In each room, the heat storage capacity or the heat insulation capacity represented by a heat storage factor varies the cooling performance and heating performance of the interior 1c. FIGS. 3A and 3B are diagrams for describing an influence of a heat storage capacity. As an example, FIGS. 3A and 3B illustrate how the heated room temperature is decreased by the outside temperature in winter. As illustrated in FIG. 3A, a house with a good heat storage capacity, such as a reinforced concrete apartment, has a high heat storage capacity, and a decrease in the heated room temperature is small. Therefore, the room temperature decreases due to the influence of the outside temperature four hours after the air conditioner stops. On the other hand, as illustrated in FIG. 3B, a house with a poor heat storage capacity, such as a prefabricated school building, has a low heat storage capacity, and a decrease in the heated room temperature is large. Therefore, the room temperature decreases due to the influence of the outside temperature one hour after the air conditioner stops.

In this manner, the room environment varies the cooling performance and the heating performance. Therefore, if information such as the operation result related to air-conditioning control in each of the rooms with different users is collected into the cloud and used as training data, a machine learning model with poor performance is highly likely to be generated.

Therefore, the air-conditioning control server 10 according to the first embodiment extracts, based on statistical information that is associated with the heat storage factor of the target space and is generated from the operation result of the air conditioner installed in the target space, information regarding a plurality of other air conditioners similar to the air conditioner. The air-conditioning control server 10 operates the air conditioner based on control parameters generated based on the extracted information.

For example, the air-conditioning control server 10 extracts, for each user, the operation results of similar environments from the operation results collected in the cloud based on the heat storage factor. The air-conditioning control server 10 generates a machine learning model or the like using the operation results of the similar environments to perform appropriate air-conditioning control in consideration of the heat storage capacity of the target space.

### Functional Configuration

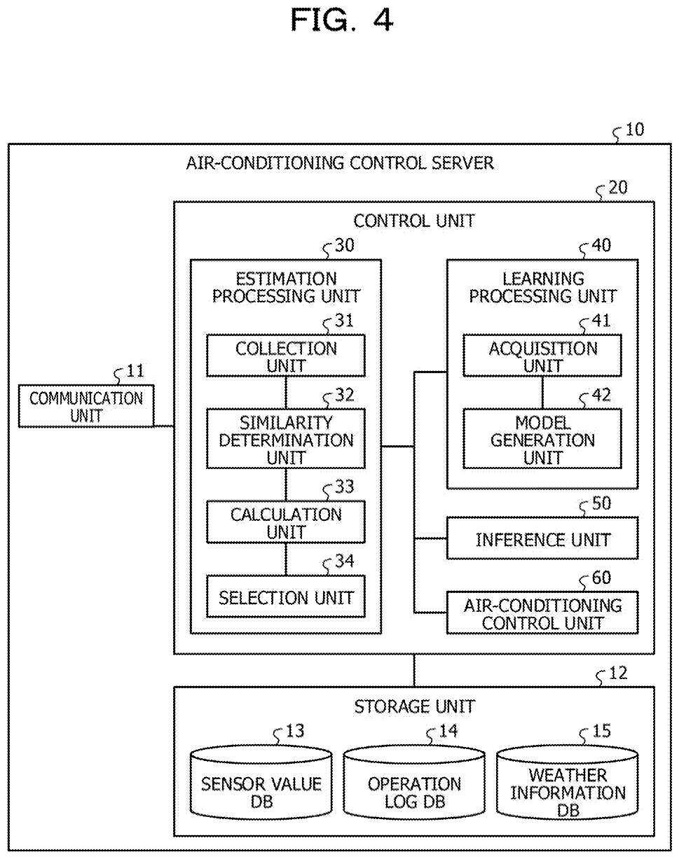

FIG. 4 is a functional block diagram illustrating a functional configuration of an air-conditioning control server according to the first embodiment. The air-conditioning control server illustrated in FIG. 4 may be the air-conditioning control server 10 illustrated in FIG. 1. As illustrated in FIG. 4, the air-conditioning control server 10 includes a communication unit 11, a storage unit 12, and a control unit 20.

The communication unit 11 is a processing unit that controls communication with other devices. The communication unit 11 is, for example, a communication interface. For example, the communication unit 11 transmits and receives data to/from an administrator terminal. The communication unit 11 receives various data such as the operation result, air-conditioning control information, and operation log from devices such as the air conditioner installed in each room, the remote controller, and the outdoor unit, and transmits a command and information for air-conditioning control to the devices.

The storage unit 12 is an example of a storage device that stores data and a program that is executed by the control unit 20. The storage unit 12 is a memory or a hard disk, for example. The storage unit 12 stores a sensor value DB 13, an operation log DB 14, and a weather information DB 15.

The sensor value DB 13 is a database that stores sensor values related to the outside temperature and the room temperature acquired by the sensor in each room. For example, each sensor value stored in the sensor value DB 13 is information acquired by the air-conditioning control server 10 from the sensor 4 and may also include other information that may be measured by the sensor 4, such as a temporal temperature change. The sensor value DB 13 stores the sensor values for each user, for example, the sensor values for each sensor in different spaces.

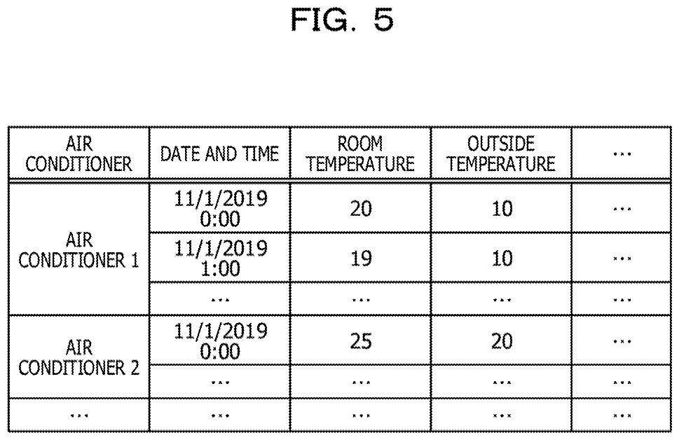

FIG. 5 is a diagram illustrating an example of information stored in a sensor value DB. The sensor value DB illustrated in FIG. 5 may be the sensor value DB 13 illustrated in FIG. 4. As illustrated in FIG. 5, the sensor value DB 13 stores “AIR CONDITIONER,” “DATE AND TIME,” “ROOM TEMPERATURE,” and “OUTSIDE TEMPERATURE” in association with each other, for example. “AIR CONDITIONER” stored in the sensor value DB 13 represents an identifier for identifying the air conditioner. “DATE AND TIME” represent the date and time when the data was measured. “ROOM TEMPERATURE” represents the temperature in the room measured by the sensor in each room. “OUTSIDE TEMPERATURE” represents the outdoor temperature measured by the sensor in each room. The sensor values for each hour are illustrated in FIG. 5. Taking an air conditioner 1 as an example, the room temperature was 20 degrees and the outside temperature was 10 degrees at 0:00 on Nov. 1, 2019.

The operation log DB 14 is a database that stores log information related to the operation of the air conditioner in each room. The log information stored in the operation log DB 14 is information acquired by the air-conditioning control server 10 from each air conditioner, the remote controller of each air conditioner, and the like, and may also include other information that may be measured by the air conditioner, such as a set temperature. The operation log DB 14 stores the operation log for each user, for example, the operation log for each air conditioner in different spaces.

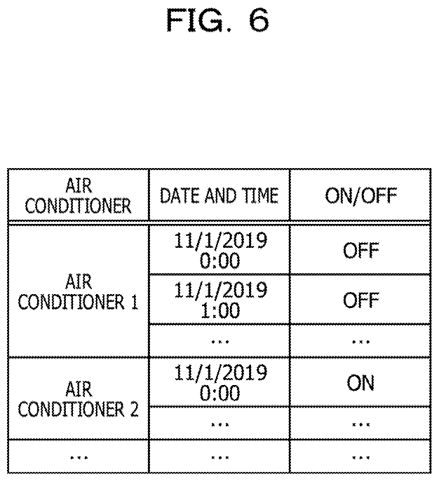

FIG. 6 is a diagram illustrating an example of information stored in an operation log DB. The operation log DB illustrated in FIG. 6 may be the operation log DB 14 illustrated in FIG. 4. As illustrated in FIG. 6, the operation log DB 14 stores “AIR CONDITIONER,” “DATE AND TIME,” and “ON/OFF” in association with each other. “AIR CONDITIONER” stored in the operation log DB 14 represents an identifier for identifying the air conditioner. “DATE AND TIME” represent the date and time when the data was measured. “ON/OFF” represents the operation log of each air conditioner. In the example in FIG. 6, the air conditioner 1 was OFF at 0:00 on Nov. 1, 2019.

The weather information DB 15 is a database that stores weather information acquired from an external weather server or the like. For example, the weather information DB 15 stores observation values of the outside temperature and humidity, forecast values of the outside temperature and humidity, and the weather acquired by the air-conditioning control server 10 from the weather server at a desired timing.

The storage unit 12 may store various types of information other than the DBs described above. For example, the storage unit 12 stores the target time and the target temperature (room temperature) for air-conditioning control, a physical model calculated by the control unit 20 described later, various coefficients and parameters of the physical model, and a generated operation plan. The target time and the target temperature may be arbitrarily set by the user, for example.

The control unit 20 is a processing unit that controls the entire air-conditioning control server 10. The control unit 20 is a processor, for example. The control unit 20 includes an estimation processing unit 30, a learning processing unit 40, an inference unit 50, and an air-conditioning control unit 60. The estimation processing unit 30, the learning processing unit 40, the inference unit 50, and the air-conditioning control unit 60 are examples of electronic circuits included in the processor and examples of processes executed by the processor.

The estimation processing unit 30 is a processing unit that includes a collection unit 31, a similarity determination unit 32, a calculation unit 33, and a selection unit 34 and estimates users (occasionally simply referred to as similar users) whose environments are similar to a control target user. For example, the estimation processing unit 30 extracts appropriate training data from all the data collected in the cloud.

The collection unit 31 is a processing unit that collects various data from the sensor and the like in each room. For example, the collection unit 31 acquires the sensor values from each sensor and stores the sensor values in the sensor value DB 13. The collection unit 31 also acquires the operation log from each air conditioner and stores the operation log in the operation log DB 14. For example, the collection unit 31 collects various data to be used as the training data in the cloud.

The similarity determination unit 32 is a processing unit that determines a similarity between the target user and each user collected in the cloud and extracts similar data. For example, the similarity determination unit 32 uses a known method such as cosine similarity (cos similarity) to identify information measured in environments similar to the environment of the target user from the information stored in the sensor value DB 13 and the information stored in the operation log DB 14.

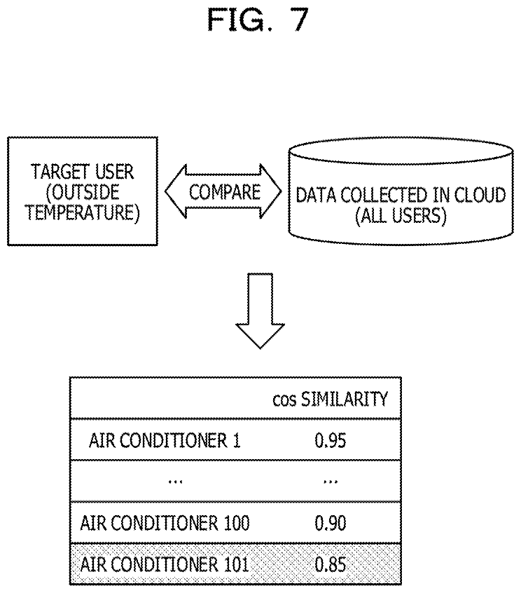

FIG. 7 is a diagram illustrating results of calculation of a similarity between outside temperatures. As illustrated in FIG. 7, the similarity determination unit 32 acquires, from the sensor value DB 13 or the corresponding sensor, the outside temperature of the target user for which air-conditioning control is performed. Subsequently, the similarity determination unit 32 calculates a cos similarity between the outside temperature of the target user and the outside temperature of each of all users (all air conditioners) stored in the sensor value DB 13 in the cloud. Then, the similarity determination unit 32 identifies air conditioners having a similarity that is equal to or greater than a threshold value (e.g., 0.9) as air conditioners (similar users) having a high similarity to the target user.

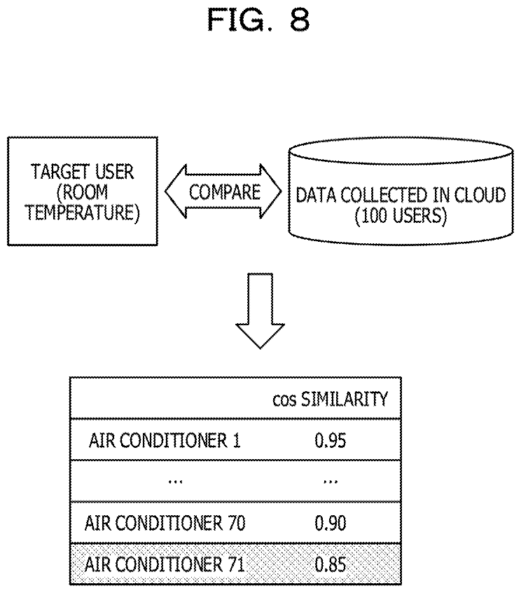

The similarity determination unit 32 may also determine a similarity between the room temperatures. FIG. 8 is a diagram illustrating results of calculation of a similarity between room temperatures. As illustrated in FIG. 8, the similarity determination unit 32 acquires the room temperature of the target user from the sensor value DB 13 or the corresponding sensor. Subsequently, the similarity determination unit 32 calculates a cos similarity between the room temperature of the target user and the room temperature of each of all users (all air conditioners) stored in the sensor value DB 13 in the cloud. Then, the similarity determination unit 32 identifies air conditioners having a similarity that is equal to or greater than the threshold value (e.g., 0.9) as air conditioners having a high similarity to the target user. The similarity determination unit 32 may narrow down data of the users having a high similarity in the outside temperature from all data and determine a similarity between the room temperatures of the users narrowed down.

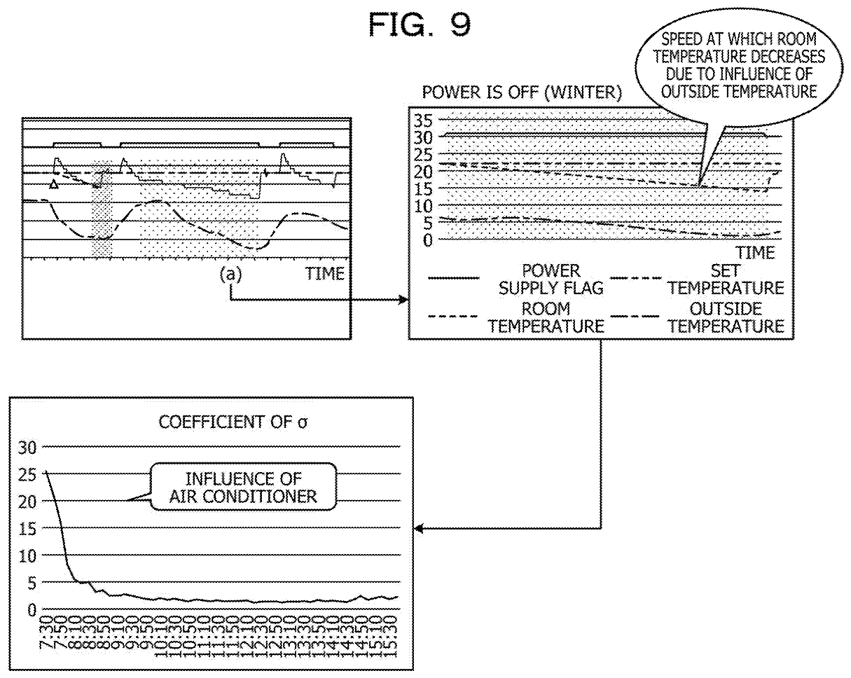

The calculation unit 33 is a processing unit that calculates the heat storage factor from the outside temperature and the room temperature for each of the target user and the users having a high similarity. FIG. 9 is a diagram for describing a heat storage factor. The example in FIG. 9 represents winter data, illustrating how the items such as ON/OFF of the air conditioner, the set temperature, the room temperature, and the outside temperature change over time. As illustrated in (a) of FIG. 9, the heat storage factor when the power is OFF may be calculated from the speed at which the room temperature decreases in the target space due to the influence of the outside temperature when the power is OFF. The heat storage factor when the power is ON may be calculated from the air-conditioning performance of the air conditioner and the speed at which the room temperature increases in the target space when the power is ON.

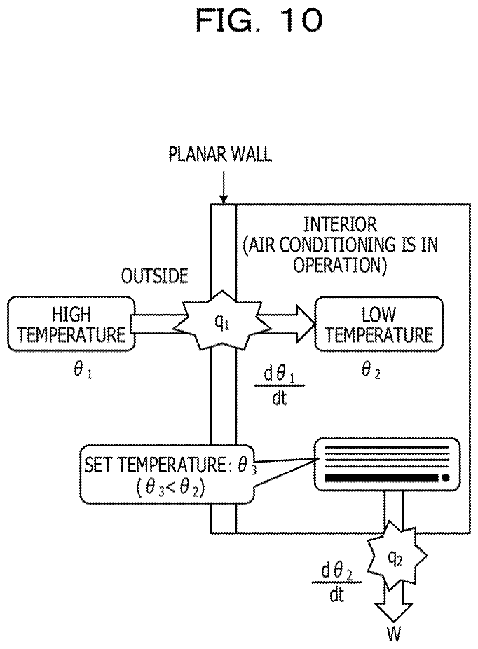

How to calculate the heat storage factor will be described in detail. FIG. 10 is a diagram for describing a method for calculating a heat storage factor. As illustrated in FIG. 10, the outdoor temperature (outside temperature) is assumed to be θ₁, the room (space) temperature is assumed to be θ₂, and the set temperature of the air conditioner is assumed to be θ₃, where θ₁>θ₂ and θ₂>θ₃ hold. It is assumed that the outside temperature θ1 does not change due to the movement of heat, and the room (space) temperature θ₂ is the same throughout the room. The amount of heat q₂ released per unit time by the operation of the air conditioner is assumed to be substantially constant without depending on θ₂, while q₁ is assumed to be the amount of heat entering from the outside to the interior (space). The outflow of heat from the target space (room) to the outside is not taken into consideration.

In this condition, the air conditioner capacity (βW) per unit time of the air conditioner may be defined as Expression (1), while the heat storage factor may be defined as Expression (2). The calculation unit 33 calculates the heat storage factor when the power is ON using Expression (2) and the information illustrated in FIG. 9 that is collected by the sensor and the like. The calculation unit 33 also calculates the heat storage factor when the power is OFF using Expression (2) and the information illustrated in (a) of FIG. 9 that is collected by the sensor and the like. For example, when the outside temperature is θ₁ and the room temperature θ₂ is 16, the heat storage factor σ calculated using Expression (2) is σ₁₆. The value of a full power such as 257.6 may be used as the air conditioner capacity (βW).

$$\begin{matrix}[ Math . 1 ] & \\ β W = {σθ}_{1} - \frac{σ ( {θ}_{2} - {θ}_{0} \cdot {e}^{- σ t} )}{1 - {e}^{- σ t}} & Expression ( 1 ) \\ [ Math . 2 ] & \\ σ = - \frac{log ( \frac{{θ}_{2} - {θ}_{1}}{{θ}_{0} - {θ}_{1}} )}{t} & Expression ( 2 )\end{matrix}$$

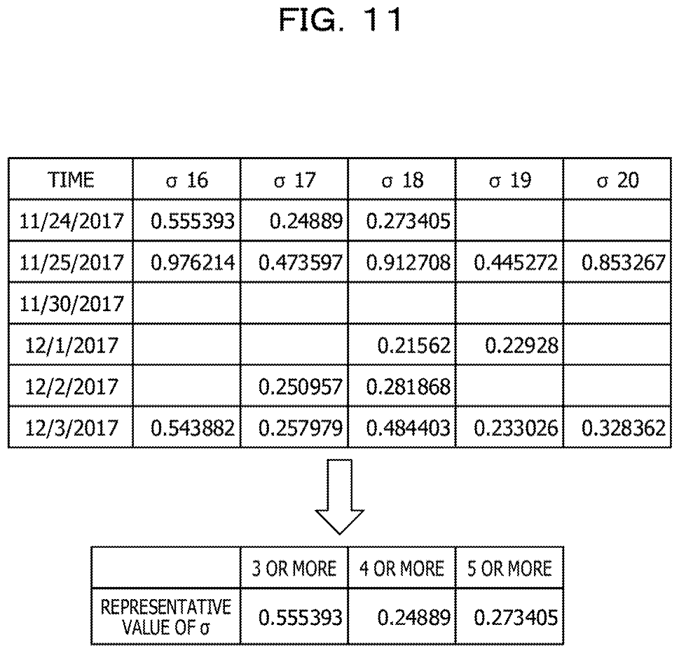

The calculation unit 33 calculates the heat storage factor by substituting the room temperature and the outside temperature into Expression (2) for each user (air conditioner) having a high similarity. FIG. 11 is a diagram for describing calculation of a heat storage factor. As illustrated in FIG. 11, the calculation unit 33 acquires the sensor values (room temperature=16 degrees) measured on Nov. 24, 2017 for a first user having a high similarity, and calculates the heat storage factor σ₁₆ using a room temperature of 16 degrees and the outside temperature at that time. Subsequently, the calculation unit 33 acquires the sensor values (room temperature=17 degrees) measured on Nov. 25, 2017 for the first user and calculates the heat storage factor σ₁₇ using a room temperature of 17 degrees and the outside temperature at that time. In this manner, the calculation unit 33 calculates the heat storage factor on each date for the first user.

Similarly, the calculation unit 33 acquires the sensor values (room temperature=16 degrees) measured on Nov. 24, 2017 for a second user having a high similarity, and calculates the heat storage factor σ₁₆ using a room temperature of 16 degrees and the outside temperature at that time. Subsequently, the calculation unit 33 acquires the sensor values (room temperature=20 degrees) measured on Nov. 25, 2017 for the second user and calculates the heat storage factor σ₂₀ using a room temperature of 20 degrees and the outside temperature at that time. In this manner, the calculation unit 33 calculates the heat storage factor on each date for the second user.

The calculation unit 33 calculates the heat storage factor for each user having a high similarity. Although there are days on which the calculation unit 33 does not calculate the heat storage factor depending on a relationship between the outside temperature and the room temperature, the calculation unit 33 calculates the heat storage factor σ for each date and calculates the average value of the values calculated for the respective users. The calculation results are illustrated in FIG. 11. For example, as illustrated in FIG. 11, the calculation unit 33 calculates, for Nov. 24, 2017, the average value of σ₁₆ of the users corresponding to a room temperature of 16 degrees, the average value of σ₁₇ of the users corresponding to a room temperature of 17 degrees, and the average value of σ₁₈ of the users corresponding to a room temperature of 18 degrees. Similarly, the calculation unit 33 calculates, for Nov. 25, 2017, the average value of σ₁₆ of the users, the average value of σ₁₇ of the users, the average value of σ₁₈ of the users, the average value of σ₁₉ of the users, and the average value of σ₂₀ of the users.

After that, the calculation unit 33 determines a representative value based on the frequency for each room temperature. In the example in FIG. 11, the calculation unit 33 determines the representative value as “0.555393” of σ₁₆ among σ₁₆, σ₁₇, σ₁₈, and σ₁₉ where three or more heat storage factors have been calculated. Similarly, the calculation unit 33 determines the representative value as “0.24889” of σ₁₇ among σ₁₇ and σ₁₈ where four or more heat storage factors have been calculated. The calculation unit 33 also determines the representative value as “0.273405” of σ₁₈ from σ₁₈ where five or more heat storage factors have been calculated. The average value may also be used as the representative value.

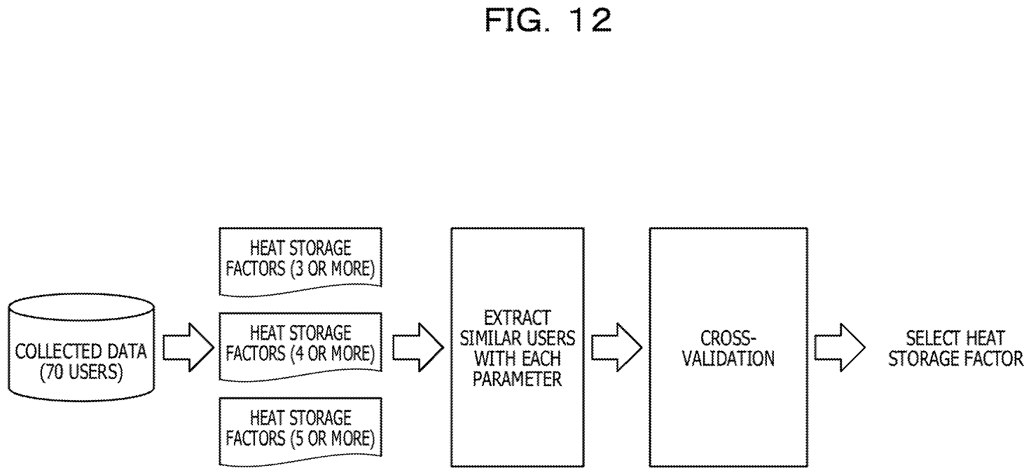

The selection unit 34 is a processing unit that selects the heat storage factor to be used for the physical model or the like using the calculation results obtained by the calculation unit 33. FIG. 12 is a diagram for describing selection of a heat storage factor. As illustrated in FIG. 12, the selection unit 34 identifies users (air conditioners) corresponding to the heat storage factors whose frequency is three or more times, four or more times, and five or more times for each, and selects the heat storage factor by cross-validation using the sensor values corresponding to the respective users. The selection unit 34 selects the heat storage factor with the best cross-validation result.

Taking FIG. 11 as an example, the selection unit 34 acquires the sensor values of similar users used for calculation of any of σ₁₆, σ₁₇, σ₁₈, and σ₁₉ where the frequency of the heat storage factor is three or more times. Similarly, the selection unit 34 acquires the sensor values of similar users used for calculation of any of σ₁₇ and σ₁₈ where the frequency of the heat storage factor is four or more times, and acquires the sensor values of similar users used for calculation of σ₁₈ where the frequency of the heat storage factor is five or more times.

After that, the selection unit 34 performs cross-validation using the sensor values when the frequency of the heat storage factor is three or more times, the sensor values when the frequency of the heat storage factor is four or more times, and the sensor values when the frequency of the heat storage factor is five or more times. If the best result is obtained with the sensor values when the frequency of the heat storage factor is three or more times, the selection unit 34 outputs, to the learning processing unit 40, “0.555393” which is the representative value when the frequency of the heat storage factor is three or more times.

The selection unit 34 may select the heat storage factor using the Euclidean distance between the heat storage factors of similar users. For example, the selection unit 34 calculates the heat storage factor for each of the following ranges: the frequency of the heat storage factor σ is two or more times, three or more times, and four or more times. Subsequently, the selection unit 34 determines the following parameter using cross-validation for each user. For each range of the heat storage factor, for example, the selection unit 34 selects similar users in ascending order of “(1−cos similarity of the room temperature)+Euclidean distance between the heat storage factors” and identifies the number of sensor values acquired from the selected similar users. Then, the selection unit 34 determines the sensor values of the selected top similar users as the training data. The number of top similar users to be used for the training data may be any number.

The selection unit 34 may also select the average value of the heat storage factors of all the similar users and the variance value of the heat storage factors of all the similar users, for example.

Referring back to FIG. 4, the learning processing unit 40 is a processing unit that includes an acquisition unit 41 and a model generation unit 42 and generates the machine learning model or the physical model.

The acquisition unit 41 is a processing unit that acquires information for generating the machine learning model or the physical model using the processing result of the selection unit 34. For example, when the heat storage factor is selected by the estimation processing unit 30, the acquisition unit 41 acquires the selected heat storage factor. When the training data are selected by the estimation processing unit 30, the acquisition unit 41 acquires the sensor values selected as the training data from the sensor value DB 13. The acquisition unit 41 outputs each acquired information to the model generation unit 42.

For example, the acquisition unit 41 acquires the heat storage factor σ=“0.555393” selected by the selection unit 34 and outputs the heat storage factor σ=“0.555393” to the model generation unit 42. When the top 100 sensor values are selected by the selection, unit 34, the acquisition unit 41 acquires the selected sensor values from the selection unit 34 or the sensor value DB 13 and outputs the acquired sensor values to the model generation unit 42.

The model generation unit 42 is a processing unit that generates the machine learning model or the physical model using the information acquired by the acquisition unit 41. For example, when σ=“0.555393” is acquired as the heat storage factor, the model generation unit 42 uses this heat storage factor to generate the physical model that predicts a room temperature change until the target time, based on, for example, the outside temperature, the room temperature, and the power supply state one hour before the target time. For example, the model generation unit 42 calculates the air-conditioning control time using the following Expressions (3) and (4).

{(Room temperature−target temperature)×β}/cooling performance per unit time Expression (3)

Air-conditioning control time=Expression (3)+((Heat radiation from the wall to the interior+influence of outside temperature (σ))/cooling performance per unit time) Expression (4)

β is constant calculated by (dQ₂/dt)=β(q₁−q₂). “Cooling performance per unit time” corresponds to “βW” expressed by Expression (1) and is 257.6, for example. “Heat radiation from the wall to the interior” corresponds to “q₁=α(θ₁−θ₂)” (α is a constant). “Influence of outside temperature (σ)” corresponds to the heat storage factor selected by the selection unit 34 and is “σ=0.555393” in the above example. The physical model illustrated herein is an example, and it is possible to employ various physical models using the heat storage factor that predict a room temperature change.

The model generation unit 42 may generate the machine learning model that predicts the room temperature one hour after the current time by using, as the training data, the sensor values of the top similar users acquired by the acquisition unit 41. For example, the model generation unit 42 acquires the operation logs corresponding to the acquired sensor values from the operation log DB 14 and acquires the changes in the outside temperatures from the weather information DB 15. Then, the model generation unit 42 performs machine learning by using the room temperatures of the sensor values as response variables and the other outside temperatures, operation logs, and changes in the outside temperatures as explanatory variables. In this manner, the model generation unit 42 generates the machine learning model (prediction model) that predicts the room temperature in one hour from the outside temperatures, the operation logs, and the changes in the outside temperatures.

The inference unit 50 is a processing unit that estimates the room temperature and the room temperature change using the model generated by the model generation unit 42. For example, when the model generation unit 42 generates the physical model that predicts the room temperature change in one hour, the inference unit 50 acquires Expressions (3) and (4) from the model generation unit 42. Then, the inference unit 50 inputs the current room temperature and the target temperature of the target user into Expressions (3) and (4) to calculate the air-conditioning control time. The air-conditioning control time indicates the cooling time or the heating time taken to reach the target temperature by the target time. After that, the inference unit 50 outputs the calculation result to the air-conditioning control unit 60.

When the machine learning model is generated by the model generation unit 42, the inference unit 50 acquires the current sensor values including the current room temperature and the current outside temperature of the target user from the sensor and the like of the target user, while acquiring the current operation status of the air conditioner. The inference unit 50 also acquires the change in the outside temperature in the local area of the target user from the weather information DB 15. After that, the inference unit 50 inputs the sensor values, the operation status (operation log), and the change in the outside temperature into the machine learning model as input data. Then, the inference unit 50 acquires the output result of the machine learning model and outputs the output result to the air-conditioning control unit 60.

The air-conditioning control unit 60 is a processing unit that performs the air-conditioning control according to the inference result of the inference unit 50. For example, when the air-conditioning control time is calculated by the physical model of the inference unit 50, the calculated air-conditioning control time indicates the time taken to reach the target temperature by the target time. Therefore, the air-conditioning control unit 60 operates the air conditioner the air-conditioning control time before the target time. For example, when the time taken to reach the target temperature (28 degrees) by the target time (6:00) is “40 minutes (air-conditioning control time),” the air-conditioning control unit 60 transmits an instruction to operate the air conditioner to the air conditioner or the remote controller of the target user at 5:20. The set temperature at this time is the target temperature.

When the output result of the machine learning model of the inference unit 50 indicates “a decrease in the room temperature,” the air-conditioning control unit 60 predicts that the room temperature will become lower than the target temperature by the target time and operates the air conditioner to heat the room. For example, the air-conditioning control unit 60 transmits an instruction to operate the air conditioner to the air conditioner or the remote controller of the target user one hour before the target time so that the room temperature will reach the target temperature (28 degrees) by the target time (6:00). The set temperature at this time is the target temperature.

### Flow of Processing

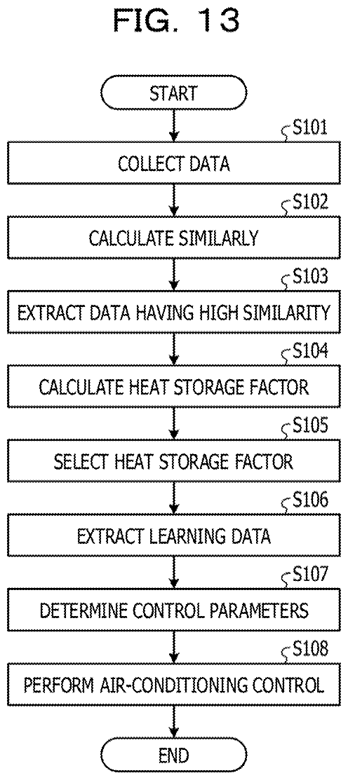

FIG. 13 is a flowchart illustrating a flow of processing. As illustrated in FIG. 13, the estimation processing unit 30 of the air-conditioning control server 10 collects data such as the sensor values from the sensor and the like of each user (S101).

Subsequently, the estimation processing unit 30 calculates a similarity using the sensor values of the outside temperature and the room temperature to search for users similar to the target user (S102), and extracts data having a high similarity as data of the similar users (S103).

The estimation processing unit 30 calculates the heat storage factor for each similar user (S104), and selects the heat storage factor among these heat storage factors using the method such as cross-validation (S105).

After that, the learning processing unit 40 acquires data such as the sensor values to be used as the training data from each DB based on the selected heat storage factor (S106), and determines the control parameters for the machine learning model or the physical model (S107). The air-conditioning control unit 60 performs air-conditioning control over the target space of the target user based on the inference result of the inference unit 50 using the control parameters (S108).

### Effect

As described above, even when data of the target user are scarce, the air-conditioning control server 10 is capable of extracting data of users in environments similar to the environment of the target user among data of other users stored in the cloud. Even when the data of the target user alone do not suffice, the air-conditioning control server 10 is capable of calculating the control parameters by supplementing appropriate data. Therefore, the air-conditioning control server 10 is capable of performing air-conditioning control using the appropriate control parameters.

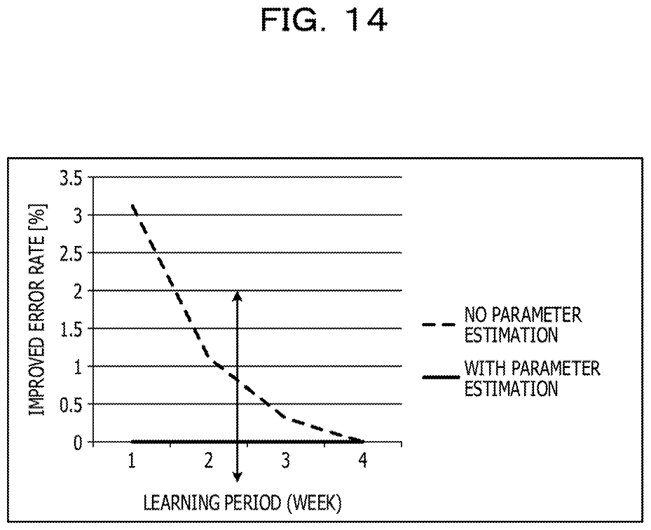

FIG. 14 is a diagram for describing an effect. FIG. 14 illustrates a relationship between the learning period and the improved error rate. As illustrated in FIG. 14, in the case of “no parameter estimation” where the method according to the first embodiment is not employed, prediction is performed with high accuracy with the sensor values collected for approximately four weeks. However, the prediction accuracy is poor in a short period of approximately one week. On the other hand, in the case of “with parameter estimation” where the method according to the first embodiment is employed, even when the sensor values have been collected for a short period of approximately one week, prediction is performed with high accuracy. With the method according to the first embodiment, therefore, even when the collection period of the sensor values is short, prediction may be performed with high accuracy.

### Second Embodiment

While the embodiment of the present invention has been described above, the present invention may be implemented in various different modes other than those in the above-described embodiment.

### Target Space

While the room in an office or the like has been described as an example of the target space in the above-described embodiment, the present invention is not limited thereto. For example, the interior of a train or a vehicle, a machine room, the interior of a plane, or any other various spaces may be the target space.

### Numerical Values

The items, numerical values, and the like of the sensor values in the above-described embodiment are not limited to those illustrated in the drawings, and may use information that may be collected by a wearable terminal, a sensor, or the like. In the above example, moreover, the room temperature in one hour is predicted. However, the present invention is not limited thereto and the time may be changed to any desired time. For example, the room temperature in 30 minutes or 2 hours may be predicted. In that case, the collection unit of the sensor values and the like is changed to the desired time such as 30 minutes, instead of 1 hour. In the above example, moreover, the sensor values and the operation logs are used as the training data. However, the present invention is not limited thereto and the sensor values alone may be used as the training data.

### Edge Control

For example, the air-conditioning control server 10 may distribute the learned machine learning model or the physical model to an edge terminal such as a computer, a communication device, or the remote controller of the air conditioner in the target space, and the edge terminal may perform prediction processing and air-conditioning control using the machine learning model or the physical model. The sensor values and the operation log may also be acquired from various devices in the room.

### System

Any change may be made to processing procedures, control procedures, specific names, and information including various data and parameters described in the above embodiment and drawings unless otherwise specified.

The components of the devices illustrated in the drawings are functional concepts and do not need to be physically configured as illustrated in the drawings. For example, concrete forms of the distribution and integration of the devices are not limited to those illustrated in the drawings, and all or part of the devices may be functionally or physically distributed or integrated in any desired unit depending on various loads and operating conditions. For example, the estimation processing unit 30, the learning processing unit 40, the inference unit 50, and the air-conditioning control unit 60 may be implemented by separate devices.

All or any desired part of the processing functions executed by each device may be implemented by a central processing unit (CPU) and a program analyzed and executed by the CPU, or may be implemented as hardware using wired logic.

### Hardware

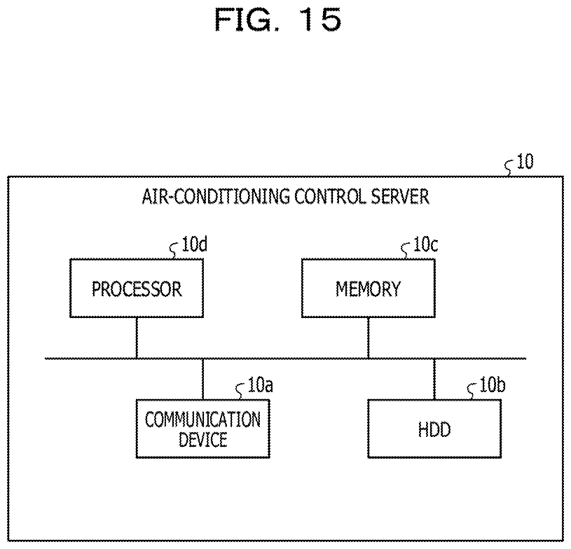

FIG. 15 is a diagram illustrating an example of a hardware configuration. As illustrated in FIG. 15, the air-conditioning control server 10 includes a communication device 10a, a hard disk drive (HDD) 10b, a memory 10c, and a processor 10d. The units illustrated in FIG. 15 are mutually coupled to each other via a bus or the like.

The communication device 10a is a network interface card or the like and communicates with other servers. The HDD 10b stores the program and the DBs that operate the functions illustrated in FIG. 4.

The processor 10d reads the program that executes the similar processing to the processing units illustrated in FIG. 4 from the HDD 10b or the like and loads the program into the memory 10c to operate processes that execute the similar functions to those described with reference to FIG. 4 and other drawings. For example, these processes execute the similar functions to the processing units included in the air-conditioning control server 10. For example, the processor 10d reads the program having the similar functions to the estimation processing unit 30, the learning processing unit 40, the inference unit 50, the air-conditioning control unit 60, and the like from the HDD 10b or the like. Then, the processor 10d executes the processes that execute the similar processing to the estimation processing unit 30, the learning processing unit 40, the inference unit 50, the air-conditioning control unit 60, and the like.

In this manner, the air-conditioning control server 10 reads and executes the program to operate as an information processing device that executes the air-conditioning control method. The air-conditioning control server 10 may cause a medium reader to read the program from a storage medium and execute the read program to implement the similar functions to those in the above-described embodiment. The program referred to herein is not limited to being executed by the air-conditioning control server 10. For example, when another computer or server executes the program or when the computer and server execute the program in cooperation with each other, the present invention may also be similarly applied.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An operation control method executed by a computer, the operation control method comprising:
extracting, based on statistical information that is associated with a heat storage factor of a target space and is generated from an operation result of a first air conditioner, information related to a plurality of other air conditioners similar to the first air conditioner; and
executing an operation of the first air conditioner based on the extracted information.

2. The operation control method according to claim 1, the operation control method further comprising:
collecting the statistical information including pieces of history information of respective spaces including the target space, each of the history information including a room temperature and an outside temperature of a corresponding one of the spaces, the room temperature and the outside temperature being associated with each other;
calculating a similarity between the history information of the target space and the history information of each of other spaces; and
calculating the control parameter using the history information of the target space and the history information of each space having the similarity that is equal to or greater than a given value.

3. The operation control method according to claim 2, the operation control method further comprising:
calculating a cosine similarity between the outside temperature included in the history information of the target space and the outside temperature included in the history information of each of the other spaces or a cosine similarity between the room temperature included in the history information of the target space and the room temperature included in the history information of each of the other spaces.

4. The operation control method according to claim 3, the operation control method further comprising:
generating a physical model that predicts a temperature change in the target space based on the control parameter,
wherein the executing process includes planning the operation of the first air conditioner according to an output result obtained by inputting a current room temperature and a target temperature of the target space into the physical model.

5. The operation control method according to claim 2, the operation control method further comprising:
receive a machine learning model that predicts a temperature in the target space, the machine learning model generated by learning the history information of each space having the similarity that being equal to or greater than a given value,
wherein the executing process includes planning the operation of the first air conditioner based on an output result outputted by the machine learning model when a current room temperature of the target space and a current outside temperature of the target space are inputted to the machine learning model.

6. A non-transitory computer-readable storage medium storing a program that causes a computer to execute a process, the process comprising:
extracting, based on statistical information that is associated with a heat storage factor of a target space and is generated from an operation result of a first air conditioner, information related to a plurality of other air conditioners similar to the first air conditioner; and
executing an operation of the first air conditioner based on the extracted information.

7. An operation control device, comprising:
a memory; and
a processor coupled to the memory and the processor configured to:
extract, based on statistical information that is associated with a heat storage factor of a target space and is generated from an operation result of a first air conditioner, information related to a plurality of other air conditioners similar to the first air conditioner, and
execute an operation of the first air conditioner based on the extracted information.

8. The operation control device according to claim 7, wherein the processor is configured to:
collect the statistical information including pieces of history information of respective spaces including the target space, each of the history information including a room temperature and an outside temperature of a corresponding one of the spaces, the room temperature and the outside temperature being associated with each other,
calculate a similarity between the history information of the target space and the history information of each of other spaces, and
calculate the control parameter using the history information of the target space and the history information of each space having the similarity that is equal to or greater than a given value.

9. The operation control device according to claim 8, wherein the processor is configured to:
calculate a cosine similarity between the outside temperature included in the history information of the target space and the outside temperature included in the history information of each of the other spaces or a cosine similarity between the room temperature included in the history information of the target space and the room temperature included in the history information of each of the other spaces.

10. The operation control device according to claim 9, wherein the processor is configured to:
generate a physical model that predicts a temperature change in the target space based on the control parameter, and
plan the operation of the first air conditioner according to an output result obtained by inputting a current room temperature and a target temperature of the target space into the physical model.

11. The operation control device according to claim 8, wherein the processor is configured to:
receive a machine learning model that predicts a temperature in the target space, the machine learning generated by learning the history information of each space having the similarity that being equal to or greater than a given value,
plan the operation of the first air conditioner based on an output result outputted by the machine learning model when a current room temperature of the target space and a current outside temperature of the target space are inputted to the machine learning model.
